(19) United States
(12) Patent Application Publication
(10) Pub. No.: US 2006/0057269 A1
(43) Pub. Date: Mar. 16, 2006

(54) Method for producing baked objects, at least parts of which are a glossy brown

(75) Inventor: Karl Tiefenbacher, Wien (AT)

Correspondence Address: LERNER GREENBERG STEMER LLP, P O BOX 2480, HOLLYWOOD, FL, 33022-2480, US

(73) Assignee: Franz Haas Waffelmaschinen-Industrie Aktiengesellschaft

(21) Appl. No.: 10/529,460

(22) PCT Filed: Sep. 18, 2003
(86) PCT No.: PCT/EP03/10363

§ 371 Date: Apr. 19, 2005

(30) Foreign Application Priority Data
Sep. 27, 2002 (AT) A1466/2002

(51) Int. Cl. A21D 10/00

(52) U.S. Cl. 426/549

(57) ABSTRACT

The invention relates to a method for producing objects, at least parts of which are a glossy brown. In a first step, an at least par-baked, dimensionally stable shaped body is produced, said body is treated as a dimensionally stable pre-product in a second step at least partially with lye. The intermediate product thus obtained can be sprinkled with a granular topping in an additional step. In the final step, the intermediate product is subjected to renewed thermal treatment, in order to brown the areas treated with lye and optionally reduce the moisture in its interior.

The invention relates to the production of baked articles which are glossy-brown at least at sites and are designed or can be used as food products, or as containers for food products, or as edible packaging etc.

### PRIOR ART

In the production of lye-treated baked goods, it is known to produce individual dough sticks from a kneadable pretzel dough having added yeast as raising agent, to shape these to form sticks, pretzels etc. and to treat the shaped raw dough pieces before baking with preferably hot aqueous caustic soda solution. During baking, the lye-treated dough pieces produce somewhat larger baked shaped bodies which have a glossy, browned exterior skin and are known as lye-treated baked goods, salt sticks, salt pretzels etc.

In the initial phase of the baking operation, the raw dough pieces which are lye-treated on their outside are heated. During this, internal deformations of the still deformable dough pieces occur as do visible changes of the very soft outer skin which, in the initial phase of the baking operation, extends together with the dough pieces and is not stabilized and solidified until the later course of the baking operation. In the interior of the dough pieces, viscous flow of the dough mass and raising of the dough by heat-caused expansion of the raising-agent gas pores, which expand further owing to the water vapor formed, occur. Towards the end of the baking operation, the characteristic color of lye-treated baked goods is formed on the outside of the shaped bodies. The aqueous caustic soda solution applied to the external skin of the raw dough pieces reacts during the baking operation with the dough constituents of the dough pieces, as a result of which the properties characteristic of lye-treated baked goods, such as color and flavor, are formed. The caustic soda solution intensifies the reaction of sugars with proteins, what is termed the Maillard reaction. This reaction proceeds in all baking processes, especially in the crust.

Bakery products known as lye-treated baked goods have a moisture content of up to 12%. They are produced from shaped dough pieces which, before baking, are treated on their outside with generally hot, aqueous caustic soda solution which has a concentration of up to 4%. During baking the raw lye-treated dough pieces then produce baked pieces having the properties characteristic of lye-treated baked goods, such as quality of the outer layer (color, consistency of the crust) and flavor. The baked pieces generally have a pretzel or stick shape. They can be sprinkled with salt, cumin or other spices.

U.S. Pat. No. 4,738,861 discloses a plant for producing pretzels. In this plant, pretzel dough is prepared continuously and shaped to form pretzel-shaped dough pieces which are treated with lye before baking.

U.S. Pat. No. 5,238,693 discloses a continuous process for producing crispy salt pretzels. In this process, dough pieces shaped to form pretzels are treated twice with lye before baking—first in a dipping bath, and then by spraying.

U.S. Pat. No. 6,352,732 discloses the production of brittle, low-fat pretzel baked goods. In the method, first, pretzels are produced in a customary method sequence. This comprises the steps: shaping the dough pieces, lye-treating the shaped dough pieces, baking the lye-treated dough pieces and post-drying the baked pieces resulting from the baking. These are coated with a sugar-containing carbohydrate solution and further dried to improve the flavor, texture and aroma of the pretzels without in this case losing color and glossiness of the surface.

U.S. Pat. No. 4,795,652 discloses a method for producing salt pretzel cone bags. In this method, a pretzel dough is rolled out and cut into individual flat sheets. The flat dough sheets are wrapped around conical mandrels to form conical bags and the parts of the flat dough sheets which project over are separated off. The conical bags which are formed from the raw flat dough sheets are coated with pretzel lye, sprinkled with salt and then baked.

U.S. Pat. No. 5,185,167 further discloses the production of a filled product from pretzel dough.

The lye treatment is customarily only used with the raw shaped dough pieces for the production of long-life and fresh baked goods. The combined heat and lye treatment and the moist oven climate cause the stabilization and closing of the outer skin of the dough pieces by the gelatinization of starch. Owing to the subsequent thermal dextrinization of the outer skin, a smooth glossy surface is achieved in the end product. In the baking process, the alkaline pH intensifies the Maillard and caramelization reactions which proceed, which lead to a deep-brown baked color and typical flavor components. The baked-article browning is promoted by the following factors: high temperature, monosaccharides (particularly fructose), alkaline pH, relatively high water content due to baked goods moisture or oven atmosphere, catalysts such as NH₃ etc. In the case of high-sugar doughs, overshooting of the Maillard and caramelization reactions can occur; this can be corrected within limits by reducing the pH.

The high temperatures prevailing during baking and the high pH produced by the lye treatment lead to a high acceleration of the chemical reactions during the baking process. Therefore, only dough pieces produced from simple low-ingredient doughs are treated with lye, which dough pieces comprise only small amounts of fat, sugars and high-protein additives. Lye treatment of raw dough pieces produced from ingredient-rich doughs, because of the high acceleration of the chemical reactions during the baking process, would lead to a rapid premature dark coloration of the outer skin and to the formation of off-odors.

### SUMMARY OF THE INVENTION

The present invention proposes a method for producing articles which are glossy-brown at least at sites, in which in a first method step an at least partially baked, dimensionally stable shaped body is produced which, as a dimensionally stable preproduct, is treated at least in part with lye in a second method step. The resultant intermediate product can be sprinkled with sprinkled material in a further method step. The last method step provides that the intermediate product, for browning its lye-treated sites and, if appropriate for reducing moisture in its depth, is subjected to a further heat treatment.

According to the invention, first, in a baking operation an at least substantially dimensionally stable shaped body is produced in which at least the outer skin is stabilized and substantially solidified. This shaped body is treated with lye at least at sites and subjected to a further heat treatment which produces a glossy-brown covering layer at its sites treated with lye. The surface details fixed in the outer skin of the shaped body in the baking operation are not lost during the lye treatment and the further heat treatment and are also retained in the glossy-brown covering layers formed by the further heat treatment.

The inventive method permits the production of baked articles having high-detail surface structures in the glossy, browned covering layers as had previously been known only in biscuits furnished with strokes, steam chimneys, edge stamps etc., or waffle sheets furnished with a smooth or finely fluted surface.

When the inventive method is carried out using baked pieces which have not been treated with lye in advance as preproduct, contrary to previously existing prejudice, surprisingly it has been found that these baked pieces, by lye treatment and short heating, can also be furnished with smooth, glossy, browned covering layers at the sites treated with lye.

According to said prejudice, with the baking of a baked piece, all of the swelling and gelatinization operations critical for the achievement of a smooth, closed surface should already have proceeded, and also the baked goods moisture promoting the Maillard reactions should be substantially removed, so that these operations or reactions in the further heating of subsequently lye-treated baked pieces should no longer suffice for the development of a smooth, closed surface.

By means of the inventive method, articles furnished on the surface at least at sites with smooth, glossy, browned covering layers can be produced not only from baked pieces which have not been treated with lye in advance, but also from doughs in which the sugar, fat or protein content on baking of lye-treated raw dough pieces would lead to unusable results.

By means of the inventive method, for the first time, articles furnished with smooth, glossy, browned covering layers can also be produced from more content-rich formulas, in which the baking of lye-treated raw dough pieces would lead to unusable results, either because, due to the severe Maillard and caramelization reactions occurring on baking, baked pieces having a dark, overbaked and burnt-appearing surface and also a surface which is no longer acceptable in terms of flavor would be formed, or because the baked pieces baked up to an attractive surface color would still be partially raw internally, incompletely baked and thus inedible and also no longer storable.

In the inventive method, from the doughs having the more content-rich formulas, in one baking operation, substantially dimensionally stable shaped bodies having stabilized and substantially solidified outer skin are produced. By applying the aqueous caustic soda solution to the baked shaped bodies, the baked-product moisture in the latter promoting the Maillard reactions is increased before the further heat treatment, so that on the lye-treated sites of the baked shaped bodies, gloss and brown color develop.

According to the invention, the dimensionally stable preproducts are produced in different ways in the first method step.

For the production of the preproducts, raw dough pieces corresponding in their shape to the articles to be produced can be baked as shaped bodies to a residual moisture of 1-29% by weight, preferably 1.5-18% by weight. The raw dough pieces can obtain their shape corresponding to the articles, for example, by stamping or cutting. However, portioned dough pieces can also be mechanically reshaped to the respective shape, before they are baked as shaped dough pieces to form dimensionally stable shaped bodies.

For the production of the preproducts, raw dough mixes or baking mixes can be prepared, portioned and baked in portions in baking molds which determine the shape of the article to be produced, to give dimensionally stable shaped bodies which have a residual moisture of 1-5% by weight, preferably 1.5-4% by weight.

For the production of the preproducts, raw dough mixes or baking mixes can be prepared, portioned and baked in portions between the opposite baking surfaces of closed waffle baking molds to give dimensionally stable shaped bodies having a residual moisture of 1-5% by weight, preferably 1.5-4% by weight.

In the inventive method, as preproducts, use can also be made of partially baked or completely baked baked pieces produced for fresh baked goods or long-life baked goods, which can also be filled. As preproducts, use can be made of, for example, biscuits, crackers, pretzels, baked sticks, baked waffles. Furthermore, as preproducts, use can also be made of filled or unfilled baked pieces which are temporarily stored chilled or temporarily stored frozen.

By means of the inventive method, not only can articles which are glossy-brown at least at sites on one side be produced, but also articles which are glossy-brown at least at sites on both sides. This includes the application of lye solutions as inscriptions or decoration patterns.

For the production of articles which are glossy-brown on one side, in the inventive method, in the production of the intermediate product, only one side of the preproduct is treated with lye and the intermediate product is subjected to a final heat treatment. This process procedure is advantageous in the production of articles constructed as hollow bodies open at one side. Cones or cups can be produced having only a visually effective glossy, browned outside. Or, for use as cones, cups or dishes provided as food containers, they can be produced having a substantially moisture-resistant, smooth, glossy, browned inside.

For the production of articles which are glossy-brown on both sides, the preproduct is first treated on one side with lye and then subjected to a first heat treatment, and then the intermediate product which is already browned on one side is likewise treated with lye on the opposite side and subjected to a second heat treatment. This process procedure permits the development of color and gloss to be arranged differently on the two sides of the articles.

In the production of the articles which are glossy-brown on both sides, for the second heat treatment, shielding of the already browned side of the intermediate product can be provided to avoid further browning of the side browned first during the second heat treatment. For this purpose, the intermediate product can be received in a holder covering its glossy-brown side and heat-treated on the side treated last with lye using hot air to develop gloss and color on this side also.

According to the invention, the lye-treated inter-mediate product can be heat-treated in a baking oven which heats the outer skin of the intermediate product to a temperature producing gloss and browning at the lye-treated sites. This heat treatment can be performed by hot air.

The lye-treated intermediate product can also be subjected to a two-phase heat treatment which consists of a baking phase and a further drying phase. In the baking phase, the outer skin of the intermediate product is heated by hot air or infrared radiation up to a temperature at which gloss and color are produced at the lye-treated sites. In the further drying phase, the interior of the intermediate product is heated, for example by microwaves or dielectrically, in order to decrease there the moisture content and reduce the moisture difference from the outer skin. This has an expedient effect on the moisture equilibration within the baked shaped bodies and reduces the risk of any later tearing of the shaped bodies.

In the lye treatment of the preproducts which have already been baked once, according to the invention, a lye solution can be used which is admixed with modified starch and/or modified cereal flour.

According to the invention, the preproducts can be allowed to cool before the lye treatment. During this, in the case of freshly baked preproducts, in particular in the case of thin-walled shaped bodies, further evaporation of residual moisture can occur.

According to the invention, the preproducts can be stored chilled before the lye treatment. This is advantageous in the event of a relatively large separation in space and time between first and second method step.

In order also to be able to bridge relatively long time periods between the production of the preproducts and their processing to intermediate products, the preproducts can be stored frozen up to the lye treatment.

In the inventive method, first, an at least partially baked, substantially dimensionally stable shaped body is produced and only then is this treated with lye and subjected to a further heat treatment. This enables not only the lye treatment of the shaped body but also the heat treatment of the shaped body producing gloss and color on its lye-treated sites each to be arranged independently of the baking operation required for its production. The browning factors, such as lye dosage, concentration of the moisture present and also duration and level of the temperature action required for development of the lye color can each be specially matched to the properties of the baked shaped body to be treated with lye.

A baked shaped body is considered to be dimensionally stable if, with gentle automatic removal from the baking mold or gentle automatic take-off from the baked-goods carrier (endless baking belt, baking sheet etc.), it no longer changes its shape, in contrast to the preceding dough phase, because, at least at the surface of the shaped body, gelatinization and substantial drying and thus solidification and stabilization of its shape has taken place.

The inventive method permits industrial fabrication of baked pieces each furnished with smooth glossy surfaces or part surfaces, for long-life baked goods or fresh baked goods such as sticks, pretzels, biscuits, cones, cups etc. Baked pieces having glossy, browned covering layers corresponding to the known lye-treated baked goods can also be produced from plastic doughs, for example pretzel dough, by the inventive method. Likewise, dimensionally stable shaped bodies produced using other dough molding and baking techniques can be used as preproduct in the inventive method, in order to produce from them baked pieces having glossy, browned covering layers. Dimensionally stable shaped bodies produced from high-sugar and/or high-protein and/or high-fat formulas can also be used as preproduct in the inventive method, in order to produce from them baked pieces having glossy, browned covering layers. Furthermore, various types of biscuits can be used as preproduct in the inventive method in order to produce from them baked pieces having glossy, browned covering layers. This applies especially to baked biscuits which have a surface which is closed and smooth to the extent that it can be treated with lye without the amount of lye required to achieve the glossy, browned covering layers leading to an adverse flavoring or nutritional effect of the finished baked pieces.

If bakery products having a solidified but still soft crumb are used as preproduct in the inventive method, the lye treatment in association with the subsequent heat treatment of the lye-treated intermediate product can lead to a “freshening” of the crumb.

The inventive method permits the production of precise shaped baked pieces having a smooth glossy surface in which the shape, formed for example as a hollow body open at one end, together with the wall thickness is determined by the opposite baking surfaces of closed baking molds. The same applies to baked goods in the form of flat bakery products in which the outline shape and surface shape of the upper sides and undersides of the bakery products are determined by conventional molding techniques of biscuit production such as baking molds, stamping, cutting out, pressing out and cutting.

Applications for articles produced by the inventive method are, for example, edible containers which are moisture-resistant for a certain time and can therefore be used for drinks, sauces, moist fillings and other foods in gastronomy, or for ice cream.

### DESCRIPTION OF EMBODIMENT EXAMPLES

The invention will be described in more detail with reference to embodiment examples.

The inventive method can be carried out in a single production line in which, in the first plant section, the preproduct with its dimensionally stable shaped bodies is produced in a first baking process, the preproduct is treated with lye in the second plant section and in a further plant section is covered with sprinkled material and the resultant lye-treated intermediate product is subjected in the last plant section to a further heat treatment in which the surface of the shaped body is browned and the interior of the shaped body is if appropriate dried.

The inventive method can also be carried out in two separate production lines, the preproduct being baked in the first production line, and not until the second production line is the lye treatment of the preproduct and the further heat treatment of the lye-treated intermediate product carried out.

With respect to the water content of the bakery product used as preproduct, it has proved to be expedient that bakery products which are customarily substantially baked dry, such as long-life baked goods, salt baked goods, hard biscuits, shaped bodies of pretzel and hard biscuit doughs, etc., should preferably be baked up to a residual moisture of less than 6%, in particular less than 4%, to minimize the risk of crack formation. For bakery products which are customarily higher in water, see the embodiment examples, these restrictions do not apply.

The baking operation for production of the preproducts makes no additional or special requirements of those skilled in the art. If a lye treatment of the preproducts is omitted in some cases, the absent lye coat results in slight adaptations which are within the experience of those skilled in the art, which relate to control of the baking oven, the baking time or any coating of the preproducts with water.

Most known baking methods are suitable for production of the preproducts with their partially or completely baked shaped bodies, for example baking in conventional baking ovens or multi-deck baking ovens on baking sheets, or baking on endless circulating baking belts in conventional continuous ovens for bread, baked goods, biscuits and salt baked goods, or baking of baking mixes or baking doughs in conventional two-part or multi part baking molds in the manner of waffle baking.

In the production of the intermediate products, as preproduct, all dimensionally stable shaped bodies having a low-porosity surface can be used which have been produced from a dough or baking mix in one baking operation. The dough or baking mixes used in the production of the preproducts can, in addition to the compositions specified in the embodiment examples, also have any other composition, provided that the dough or baking mixes are susceptible to a baking operation and the properties of the preproducts (surface structure, flavor) harmonize with the appearance and flavor of the end product resulting in the last method step by the heat treatment of the lye-treated intermediate products.

In the production of the intermediate products, those skilled in the art have the object, depending on the desired properties of the end product, such as depth of color, glossiness and flavor intensity of the surface and of the entire end product, of matching, for the lye treatment of the preproducts, the concentration and viscosity of the lye solution and its application rate per unit of surface area to the preproduct in question and, for the lye treatment, of selecting one of the known application techniques, such as spraying, spreading, pouring, dipping, printing. The lye concentration and the lye application are matched here to the type and properties of the bakery product to be used as preproduct and its sites or surface regions to be treated with lye. This matching makes it possible for those skilled in the art to control specifically the properties to be given to the end product such as depth of color, glossiness and flavor intensity of the surface and of the entire bakery product.

For the production of the end product, the intermediate product, that is to say the already lye-treated dimensionally stable shaped body which has already passed through a baking operation in its production, is subjected to a further heat treatment which produces a glossy, browned covering layer on the lye-treated sites of the intermediate product. This heat treatment of the intermediate product can be a further baking operation which produces a glossy, browned covering layer on the lye-treated sites of the intermediate product. The heat treatment of the intermediate product can also take place in two phases. Here, the intermediate product is treated, in one heat-treatment phase, with hot air on the outside in order to produce a glossy, browned covering layer on its lye-treated sites. In the other heat treatment phase, the intermediate product is heat treated with microwaves or dielectrically, in order to decrease moisture differences between its outer skin and its center.

The inventive method produces a glossy, browned surface or covering layer on the lye-treated sites or surface regions of the intermediate products, in which the measurable depth of color of the browning and the measurable glossiness are increased compared with surface browning already present in the baked, dimensionally stable shaped body of the preproduct.

By means of the inventive method, depending on the base flavor of the baked preproducts, novel interesting flavor combinations can also be produced in the end products, for example a sweet-tasting baked good having a lye-treated surface.

Articles produced by the inventive method have a modified surface texture which reduces or halts their becoming wet through. This may be due to the fact that the markedly visible development of a smooth glossy surface is also accompanied by a significant reduction of open pores in the baked goods. Articles which are produced by the inventive method and are formed, for example, as cone-shaped, cup-shaped or dish-shaped containers, are therefore particularly suitable for receiving freshly prepared ice cream, or for receiving ice cream to be stored in the frozen state, but also as dishes usable in the short term or if appropriate also edible disposable packaging for foods, for example meat preparations or vegetable preparations, sauces, salads, drinks etc.

Another field of application for the inventive method is in the decoration or inscription of bakery products and other baked dimensionally stable shaped bodies. These can be introduced into the method as preproduct and, in the production of the intermediate product, be treated with lye, for example, only at the sites or surface regions of the shaped bodies to be emphasized as decoration or inscription, so that the baked shaped bodies only receive a glossy, browned surface or covering layer in the decoration or inscription.

When baked preproducts having elevated porosity are used, open coarse pores having a diameter greater than 0.02 mm, this must be taken into account in the application technique and composition of the lye. For instance, when the preproducts are sprayed with lye, the amount applied can be controlled better and a lye solution of elevated viscosity, for example according to the examples listed below under “lye solutions” F, G, H, is advantageous. If, nevertheless, because of the excessive porosity, too much lye solution is absorbed into the interior of the shaped body, this shaped body is not suitable for a lye treatment of this type.

Preferred baked preproducts are bakery products having low-porosity surfaces. In the production of the baked shaped bodies, baking is generally associated with a skin formation on the surface and with the development of closed pores.

Those which are readily usable for the production of the shaped bodies are, for example, kneaded solid doughs for salt baked goods, as are described, for example, in “W. Seibel: Feine Backwaren” [Fine bakery products], Berlin 1991, page 150 (R1) or “E. Bergmann: Hefebackbuch” [Yeast baking manual], Stuttgart 1987, page 151 (R2).

| Formula | R1 | R2* | |
|---|---|---|---|
| Flour | 100 | 100 | |
| Baking fat | 6 | 3 | |
| Salt | 1 | 2.5 | |
| Yeast | 0.5 | 4.5 | |
| Malt | 0.15 | 2 | (malt baking agent) |
| Water, approx. | 50 | 50 | |

*add 10 parts of old dough (starter dough)

From such doughs are produced shaped bodies, such as cones or cups, in two-part or multi part baking molds. Doughs which, because of the properties of their ingredients, especially the flour, and because of the addition of baking agents or minor components, give a standard consistency of the dough even at low water addition, have a tendency on baking to lead more rapidly to uniformly baked shaped bodies of good stability than those which, with comparable ingredients and comparable production method, require a higher water addition to obtain a standard consistency.

From the doughs, balls or cubes of defined weight are produced. The dough pieces are molded in openable and closable cone or cup baking molds to form cones or cups respectively corresponding to the shaped cavities of these baking molds, and baked. The baking molds, by their opposing baking surfaces of their lower parts and upper parts when the baking mold is closed, determine the shape of the cones or cups and, by the spacing between these baking surfaces, the wall thickness of the cones or cups. Depending on the baking mold, the wall thickness of the baked cones or cups is between 1.5 and 5 mm, preferably between 1.8 and 4 mm.

The baking temperature is in the range from 155° C. to about 205° C. Depending on the dough formula and on the wall thickness of the cones or cups predetermined by the respective baking mold, the baking time is usually between 80 and 240 seconds. After this baking time, the cones or cups are at least substantially baked, have a residual moisture of usually less than 12%, and are sufficiently dimensionally stable not to be deformed or even torn apart when the respective baking mold is opened due to residual vapor still present in the baked goods. If the cones or cups are completely baked in the closed baking molds, they then have only a residual moisture of 1-6%, preferably 1-4%.

The baked cones or cups are taken out of the baking molds and, with the opening downward, at a distance from one another, are placed on a mesh belt which transports them through the lye-treatment station. The cones or cups placed on the mesh belt undergo cooling and if appropriate evaporation of residual moisture. In the lye-treatment station, a lye solution or a modified lye solution is applied to the cones or cups in the pouring or spraying method. Concentration and temperature of the lye determine the efficacy of the lye treatment and thereby the depth of color and gloss formation resulting on the lye-treated surface regions in the heat treatment of the cones or cups. Lye concentration and lye temperature can be matched to the baked cones or cups by those skilled in the art in accordance with the concentration ranges listed below under “lye solutions”.

The lye-treated cones or cups can then pass through a conventional sprinkling device in which the sprinkled material, for example salt, spices etc. is applied to the lye-treated side of the cones or cups.

In the lye-treatment station, the shaped bodies can be treated with lye on both sides or else only on partial regions of their surface. For example, the surface regions of the shaped bodies which are not to be treated can be covered with stencils. The surface regions of the shaped bodies which are to be treated can be printed in a printing operation with lye solution, in a similar manner to the application of printing inks.

When the lye solution is applied in the dipping method, the contact time in the lye bath, typically less than 10 seconds, is to be restricted, depending on the surface properties of the baked shaped bodies, or else the application of the lye solution by means of a pouring film or spraying is to be provided, to prevent excessive lye application to the surface of the baked shaped bodies or absorption of the lye by the baked shaped bodies. When the lye solution is applied in the dipping method, the contact times in the lye bath, compared with the known lye treatment of raw dough pieces, are significantly shorter and are only 50% or less.

For the lye treatment of the baked shaped bodies, diluted caustic soda solutions or caustic potash solutions or soda solutions can be used alone.

In order firstly to control the viscosity of the lye-treatment solution and its penetration and drainage behavior after application to the respective surface (more rapid viscosity rise, restricted absorption of lye solution into open pores) and secondly to improve the adhesion of sprinkled material, for instance salt or spices (increased stickiness and film formation) on the lye-treated surface, and if necessary to increase the glossiness and the coloring of the treated surface, although the critical effects certainly start from the lye itself, a modified starch or a modified cereal flour can also be dissolved in the lye solution which modified starch or modified cereal flour was selected from the group consisting of pregelatinized flours, pregelatinized starches, degraded starches and maltodextrins.

The modified starches or cereal flours, because of the breakdown in the molecular mass which has taken place in the modification, have, compared with native starch or native flour, an increased solubility in dilute lye and form a smooth film after drying in a known manner.

Development of Lye Color and Gloss:

The lye-treated and if appropriate sprinkled, baked shaped bodies form the intermediate product which is subjected to a heat treatment to develop glossiness and color on the lye-treated sites of the shaped bodies. The development of the browned glossy covering layers proceeds thermally at temperatures in the range between 160° C. and 290° C., the range between 200° C. and 250° C. being preferred.

The heat treatment can take place in a multideck baking oven or in a continuous baking oven. The intermediate products are transferred to a baking sheet or the baking belt of the continuous baking oven and treated with heat in the baking oven.

In the continuous baking oven, the passage time is typically 1 to 10 minutes, preferably 2 to 6 minutes.

The passage time is dependent on the mass of the respective intermediate product, the amount of lye applied, the temperature of lye solution and shaped bodies and the control of the heat production of the baking oven via radiation or convection.

Not only in the multideck baking oven but also in the continuous baking oven, the oven control required for development of the browned, glossy covering layers is within the range of experience of those skilled in the art, likewise the selection of the lye and its concentration.

A guideline for the technical action is as follows:
1) The proportion of water which is applied with the lye solution to the lye-treated surface causes swelling and additional smoothing and consequently additional glossiness of the surface. It is controlled in a known manner via the amount of lye solution applied.
2) The concentration of the lye applied determines, together with the temperature in the heat treatment and the composition of the intermediate product, the degree of browning achieved. It is controlled via the concentration of the lye solution. The time required to develop the browned, smooth, glossy surface depends primarily on the parameters temperature, intensity of the heat transfer by convection and radiation and amount of lye solution applied and only secondarily on the wall thickness of the shaped bodies.

To intensify the adhesiveness of the sprinkled material and the glossiness, a cold lye-treatment method with addition of modified starch can also be employed.

The finished articles are transferred to a cooling and stacking section. Depending on the type of the articles, a slow cooling (cooling section up to 40 minutes) can be required, in order to avoid cracking of the articles due to the resultant slow equilibration in the residual moisture.

### EXAMPLES OF PREPRODUCTS USABLE IN THE INVENTIVE METHOD

### Example 1

### Molded Baked Goods Made of Pretzel/Stick Doughs

Four variants of the production from pretzel doughs of baked pieces each having glossy, browned covering layers were carried out. In each case, initially dimensionally stable baked shaped bodies were produced as preproduct. The preproduct was treated with lye and on occasion covered by sprinkling. The resultant intermediate product was subjected to a further heat treatment in a hot air oven to generate the glossy-browned covering layers.

Variant 1: Preparation of a plastic dough, molding and rolling out a dough belt, stamping out dough pieces using a stamping roller, baking the stamped-out dough pieces in a baking oven with circulating baking belt, from which they are taken off as dimensionally stable baked shaped bodies. Lye treatment of the still-hot shaped bodies on the top side and sprinkling with coarse salt. Drying the lye-treated shaped bodies in the hot-air oven.

Product: From the dough belt, dough pieces are stamped out for cocktail pretzels and baked for 6 min in the hot-air oven. A solution of 2% caustic soda in water, temperature 28° C., was poured over the still-hot pretzels and the pretzels were sprinkled with coarse salt. The lye-treated and sprinkled pretzels were dried in the hot-air oven at 220° C. up to a medium depth of color.

Variant 2: Preparation of a crumby-plastic dough, from which, in a baking molding machine, using molding rollers, raw molded dough pieces are produced which are baked in a baking oven with a circulating baking belt and taken off from this as dimensionally stable baked shaped bodies. Lye treatment of the shaped bodies at room temperature by coating with a solution of 20% maltodextrin 15 and 2% caustic soda pellets solution in water. Drying the lye-treated shaped bodies in the hot-air oven as in variant 1.

Product: Round sandwich biscuits, lye treatment at room temperature (biscuits and lye).

Variant 3: Preparation of a prekneaded dough mix which is further kneaded in an extruder and extruded as continuous dough belts, dividing the dough belts into individual dough pieces which are baked in a baking oven with a circulating baking belt and are taken off from this as dimensionally stable baked shaped bodies. Lye treatment of the still-hot shaped bodies on the surface by spraying with 1.5% strength caustic soda solution (temperature approximately 40° C.). Drying the lye-treated shaped bodies in the hot-air oven.

Product: Salt sticks, extruded; baking after manual division of the extruded dough belts into individual dough sticks, lye treatment of the baked sticks directly after baking. Baked good hot, lye approximately 40° C.+.

Variant 4: Preparation of a plastic dough, portioning of the dough, introducing the dough portions into hot two-part or multipart openable and closable baking molds which reshape the dough portions on closing into the shape corresponding to the baking mold, and baking the dough portions in the closed baking molds to give dimensionally stable shaped bodies which after removal from the baking mold are treated directly after the baking operation by pouring cold lye over the outside. Drying the lye-treated shaped bodies in the hot-air oven.

Product: “Pretzelcone” lye treatment of the baked cones immediately after the baking operation by pouring cold lye (3% caustic soda solution in water, temperature 24° C.) over the cone exterior.

Formulas for Variants V1 to V4

| Raw materials (g) | V1 | V2 | V3 | V4 |
|---|---|---|---|---|
| Flour, low gluten | 100 | 93 | 97 | 100 |
| Starch | 0 | 7 | 3 | 0 |
| Fat | 4 | 4.5 | 2 | 6 |
| Salt | 1 | 0.5 | 1 | 1 |
| Fresh yeast* | 0.38 | 1 | 2 | 0.5** |
| Malt extract | 0 | 0.5 | 2.5 | 0.15 |
| Lecithin | 0 | 0.12 | 0 | 0 |
| Ammonium bicarbonate | 0 | 0 | 0.5 | 0 |
| Caustic soda | 0 | 0 | 0.35 | 0 |
| Calcium phosphate | 0 | 0 | 0.3 | 0 |
| Water, approx. | 35 | 32 | 40 | 50 |

*less with starter dough (10 to 30%);
**instant yeast

The shaped bodies are baked to be substantially dry. The residual moisture content is about 2 to 5%.

### Example 2

### Preproducts from Pizza Dough

Variant 1: Preparation of a starter dough, allowing it to rest at room temperature for at least 45 min, final mixing of a plastic dough, portioning, molding pizza dough sticks which are baked in a hot-air oven (pizza oven).

Variant 2: Preparation of a starter dough, allowing it to rest at room temperature for at least 45 min, final mixing of a plastic dough, portioning, introducing the dough portions into hot two-part or multipart openable and closable baking molds which reshape the dough portions on closing into the shape corresponding to the baking mold, and baking the dough portions in the closed baking molds to give dimensionally stable shaped bodies.

Dough formula for both variants

| | | | | | |
|---|---|---|---|---|---|
| Starter | Flour | 16 | Main dough | Flour | 108 |
| dough | Water | 16 | | Water, approx. | 48 |
| | Fresh yeast | 5 | | Fat | 2 |
| | Sugar | 1 | | Salt | |
| | | | | Baking agent | 0.25 |

The pizza dough sticks are baked to approximately 12-16% residual moisture. The lye treatment of the prebaked pizza sticks is performed immediately after baking. Lye solution as in variant 2 of example 1, in which case the maltodextrin can also be replaced by 2.5% pregelatinized wheat flour.

The shaped bodies in the baking molds are baked so as to be substantially dry to about 2 to 5% residual moisture. For a wall thickness of 4 mm: at 170° C. and approximately 180 seconds baking time. For a wall thickness of 2.5 mm: at 170° C. and approximately 100 seconds baking time.

Lye is poured over the shaped bodies as they pass through a pouring lye curtain. The concentration of the caustic soda solution is 3% in water, the starting temperature of the lye is about 28° C. The lye-treated pizza sticks are sprinkled with spices and finally baked in a hot-air oven at 240° C. for 6 minutes.

### Example 3

### Preproduct from Hard Pretzel Dough

Preparation of a plastic dough, 15 minutes resting time at room temperature, portioning the dough, introducing the dough portions into hot two-part or multipart openable and closable baking moulds which reshape the dough portions on closing into the shape corresponding to the baking mold, and baking the dough portions in the closed baking molds to give dimensionally stable shaped bodies.

Formula

| | | | |
|---|---|---|---|
| Flour | 20 | Emulsifier | 0.2 |
| Water, approx. | 10 | Salt | 0.2 |
| Fat | 2 | Dried yeast | 0.1 |
| Sugar | 0.3 | Raising agent | 0.08 |
| Baking agent | 0.3 | | |

The shaped bodies in the baking molds are baked to about 2 to 5% residual moisture. Dimensional stability in principle is provided as early as from about 20% residual moisture, but then there are great demands made of the demolding technique.

Lye is poured over the shaped bodies as they pass through a poured lye curtain. The concentration of the caustic soda solution is 3% in water, the initial temperature of the lye is about 28° C. Baking is performed to completion in a hot-air oven at 240° C. for 6 minutes.

### Example 4

### Dough Dishes (Pie Shells) as Preproduct

Variant 1: Preparation of a plastic dough which, after 15 minutes resting time in a refrigerator, is conventionally molded and baked to form dough dishes.

Variant 2: Preparation of a plastic dough, after 15 minutes resting time in the refrigerator, portioning the dough, introducing the dough portions into hot two-part or multipart openable and closable baking molds which reshape the dough portions on closing into the shape corresponding to the baking mold, and baking the dough portions in the closed baking molds to give dimensionally stable shaped bodies.

| | Formulas | | |
|---|---|---|---|
| | A | B | C |
| Flour | 10 | 10 | 10 |
| Sugar | 5 | 0.5 | 0.4 |
| Margarine | 3 | 5 | 0 |
| Baking fat | 0 | 0 | 5 |
| Fresh egg | 2 | 0 | 0 |
| Water, approx. | 2 | 4 | 5 |
| Baking agent | 0.4 | 0.1 | 0.01 |
| Salt | 0.2 | 0.18 | 0.25 |
| Emulsifier | 0.1 | 0 | 0.1 |
| Flavoring, approx. | 0.01 | 0.01 | 0.01 |

The shaped bodies are baked to be light to medium brown. The shaped bodies produced according to formula A must be demolded with support and are only susceptible to a lye treatment after cooling and solidification.

The lye treatment is performed using a solution of 30% maltodextrin 15, 1% sodium hydroxide in water (product according to formula A) or 2.5% sodium hydroxide in water (product according to formulas B, C). The initial temperature of the lye is about 28° C. Further drying in the hot-air oven at 240° C. for 4 to 6 minutes.

Lye is poured over shaped bodies as they pass through a poured lye curtain. The concentration of the caustic soda solution is 3% in water, the initial temperature of the lye is about 28° C. The lye-treated pizza sticks are sprinkled with spices and baked to completion in a hot-air oven at 240° C. for 6 minutes.

### Example 5

### Preproducts Made from Focaccia Dough

Variant 1: Preparation of a plastic dough which ferments for at least 45 min at 26 to 29° C. Portioning the dough and molding flat focaccia breads, after resting for approximately 15 minutes, baking the breads at 215° C. to 230° C. with bottom heat.

Variant 2: Preparation of a plastic dough which ferments for at least 45 min at 26 to 29° C. Portioning the dough, introducing the dough portions into hot two-part or multipart openable and closable baking molds which reshape the dough portions on closing into the shape corresponding to the baking mold, and baking the dough portions in the closed baking molds to give dimensionally stable shaped bodies.

Dough formula

| | | | |
|---|---|---|---|
| Flour, strong gluten | 10 | Dried yeast* | 0.3 |
| Water, approx. | 5 | Sugar | 0.23 |
| Olive oil | 1.1 | Salt | 0.23 |

*reactivate in advance with about three times the amount of warm water

The flat breads are baked up to a light to slightly brown crust, the crumb is soft. The lye treatment is performed in the still-hot state by coating with a 3% strength lye solution with subsequent rebaking for approximately 5 minutes.

The shaped bodies in the baking molds, in contrast, are baked to approximately 2-5% residual moisture and lye is poured over the interior. The concentration of the caustic soda solution is 3% in water, the initial temperature of the lye is about 28° C. Baking is carried out to completion in a hot-air oven at 240° C. for 6 minutes.

### Example 6

### Preproducts Made from Gingerbread (Lebkuchen) Dough

Preparation of a plastic dough in two stages (starter dough with flour, syrup, sugar, water; main dough) which is demolded with greasing and baked to completion in a steel belt oven.

Dough formula

| | | | |
|---|---|---|---|
| Flour | 10 | Spice | 0.18 |
| Syrup | 4.5 | pH regulator, approx. | 0.1 |
| Soft brown sugar | 3 | Water | 0 to 2 |
| Raising agent | 2.2 | | |

The shaped bodies are baked to light to medium brown, are coated still hot with lye (2.5% sodium hydroxide plus 50% maltodextrin 18 in water, approximately 30° C.) and completed in the hot-air oven for approximately 5 minutes at 240° C.

### Example 7

### Preproduct—Hard Biscuits

Hard biscuits from the market of the Cracker, Petit beurre, Marie type, are coated on the top side at individual sites with a lye solution (3% sodium hydroxide in water, approximately 30° C.) and dried at 240° C. for 6 minutes.

### Example 8

### Preproduct—Crackers with or Without Yeast

| Formula | with yeast | without yeast |
|---|---|---|
| Flour | 20 | 20 |
| Water, approx. | 6 | 6 |
| Fat | 1.4 | 1.3 |
| Sugar | 0.5 | 1 |
| Invert syrup | 0 | 0.5 |
| Malt flour | 0.5 | 0.3 |
| Salt | 0.3 | 0.2 |
| Emulsifier | 0.2 | 0.2 |
| Raising agent | 0.12 | 0.15 |
| Yeast | 0.05 | 0 |

The dough is fermented with yeast for at least 1 hour then it is rolled out, cut out and, after a short resting phase, baked in a conventional manner to a still bright color strength of the surfaces and a residual moisture less than 6%. The raising agent is to be adapted to the desired degree of raising.

Spraying on lye solution (2.5% strength caustic soda solution in water, approximately 30° C.)

Further drying in the hot-air oven at 240° C. for approximately 6 minutes.

### Example 9

### Preproduct “Pretzel Cones” Yeast Free

Formula

| | | | |
|---|---|---|---|
| Flour | 20 | Emulsifier | 0.2 |
| Water, approx. | 8 | Salt | 0.2 |
| Fat | 2 | Raising agent | 0.08 |
| Baking agent | 0.3 | | |

In a kneader, all components are added and a dough is kneaded (2 min slow, 5 min fast). After a resting time of at least 10 minutes at room temperature, a highly plastic dough is obtained (approximately 35% water content). Dough portions of approximately 40 g are baked in hot three-part openable and closable cone baking molds at 170° C. for about 180 seconds (cone shape smooth, wall thickness 4 mm) to give cones having a residual moisture between 2% and 5%. The cones are removed from the baking mold and transferred to a mesh belt with the cone opening downward. The cones cool somewhat during this, their surface temperature is between more than 40° C. to just below the baking temperature. Lye is poured over the cones on passage through a pouring lye curtain. The concentration of caustic soda solution is 3% in water, the initial temperature of the lye is about 28° C. The lye-treated cones are sprinkled with coarse salt and possibly also with sesame seeds and baked to completion in a hot-air oven at 240° C. for 6 minutes.

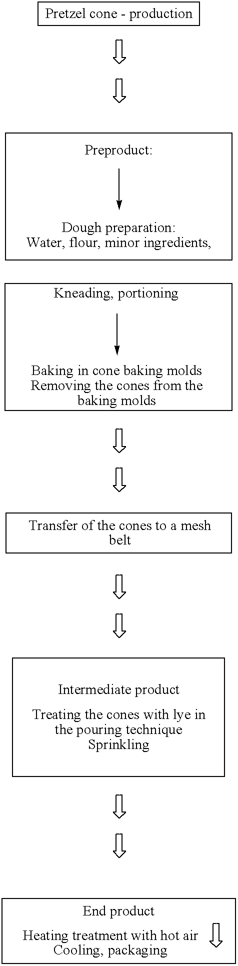

### Example 10

### Preproduct—Salt Pretzels

Preparation of a smooth, firm dough which rests for at least 15 min, division of the dough into individual dough sticks, molding the dough sticks to form pretzels having a thick stick in the center which proceeds thinner toward the outside and ends in a round end. After achieving the desired degree of fermentation, the pretzels are coated with water and baked at 230° C. for about 20 min.

The partly baked pretzels can also be chilled, stored chilled or stored frozen.

The pretzels are coated on the covering surface with 2.75% caustic soda solution (room temperature), sprinkled with salt and baked at approximately 250° C. to the desired degree of color development.

Dough formula*

| | | | |
|---|---|---|---|
| Flour, T 550 | 10 | Baking yeast | 0.45 |
| Water, approx. | 5 | Salt | 0.25 |
| Fat | 0.3 | Malt baking agent | 0.2 |

*if appropriate approximately 5% of old dough is added.

The Lye-Treatment Step

The preproducts mentioned in the above examples are treated with a lye solution in the next method step. In contrast to conventional lye treatment of raw dough pieces before baking, here any essential function of the lye-treatment step is omitted, that is to say the formation of a denatured, smooth surface skin as a consequence of the high pH and the generally high temperature of the lye bath.

The preproducts mentioned in the preceding examples are accompanied by an already stable solidified surface. In the case of open pores in the surface, an excessively long or intense lye treatment is not desirable. A criterion thereof is whether lye solution can penetrate into the interior of the preproduct. This can be avoided by changing the lye-treatment technique, for example spraying instead of pouring or dipping, and by using a lye having a higher viscosity according to the subsequent examples F to H.

The lye solution can be used hot, until just below the boiling point of the lye solution. However, it need not be used hot. Likewise, short dipping or spraying is completely sufficient to impregnate the surface of the preproduct with lye solution.

In the heat treatment of the lye-treated preproducts, a browned, glossy, frequently also smooth surface was achieved which, in the case of dense, low-porosity baked goods surfaces, even imparts a closed surface profile. This surprising effect demonstrates that the lye treatment of baked shaped bodies is sufficient to achieve this effect and that the alkaline substances here are reacted.

Depending on the desired color intensity, the reactivity of the surfaces of the baked shaped bodies which is determined by the formula, and the lye application technique chosen, such as dipping or spraying, those skilled in the art can select the concentration of the lye used, possibly also as a mixture of the preferred lye formulations.

Lye Solutions:

A Caustic soda solution in water, concentration in the range from 0.15% to 4%, preferably in the range from 0.5% to 3%. Temperature between refrigerator temperature (about 4° C.) and at least 1° C. below boiling temperature, preferably between room temperature and 95° C. At relatively low lye concentration, caustic potash lye can also be used, with a bitter taste that occurs at any rate acting here in a limiting manner.
B Caustic soda solution in ethanol/water (50%/50% v/v), concentration in the range from 0.15% to 4%, preferably 0.5% to 3%. Temperature between refrigerator temperature (about 4° C.) and 50° C., preferably room temperature. At relatively low lye concentration, caustic potash lye can also be used, with a bitter taste that occurs at any rate acting here in a limiting manner.
C Mixtures of A and B. Temperature between refrigerator temperature (about 4° C.) and 50° C., preferably room temperature.
D Sodium carbonate (soda) in water. Concentration in the range from 0.5% to 6%, preferably 1.5% to 5%. This is the monohydrate, other hydration stages required conversion for equivalence. Temperature between refrigerator temperature (about 4° C.) and at least 1° C. below boiling temperature, preferably between room temperature and 95° C. At relatively low lye concentration, calcium carbonate can also be used, with a bitter taste that occurs at any rate acting here in a limiting manner.
E Mixtures of A and D. Temperature between refrigerator temperature (about 4° C.) and at least 1° C. below boiling temperature, preferably between room temperature and 95° C.
F As A, but in addition maltodextrin (DE between 5 and 20) dissolved at a concentration of 4 to 55%, preferably 10 to 50%. Temperature between room temperature and at least 1° C. below the boiling temperature, preferably between room temperature and 60° C.
G As A, but in addition pregelatinized wheat flour dissolved at a concentration of 0.5 to 5%, preferably 1 to 4%. Temperature between room temperature and at least 1° C. below boiling temperature, preferably between room temperature and 60° C.
H Mixtures of F and G. Temperature between room temperature and at least 1° C. below boiling temperature, preferably between room temperature and 60° C.

1-20. (canceled)

21. A method for producing baked articles that are glossy-brown at least at given sites, which comprises:
producing a pre-product formed of an at least partly baked, dimensionally stable shaped body;
treating the dimensionally stable pre-product with lye and producing a lye-treated intermediate product with lye-treated sites;
optionally sprinkling the intermediate product with sprinkle material; and
heat-treating the intermediate product:
at least on a surface thereof for browning the lye-treated sites of the intermediate product; and
optionally, in a depth thereof for reducing a moisture content.

22. The method according to claim 21, wherein the step of producing the pre-product comprises baking a raw dough piece having a shape corresponding to a shape of the article to be produced to form a shaped body with a residual moisture of 1-29% by weight.

23. The method according to claim 22, which comprises baking the shaped body to a residual moisture of 1.5-18% by weight.

24. The method according to claim 21, wherein the step of producing the pre-product comprises mechanically reshaping a portioned, raw dough piece into a shape corresponding to a shape of the article to be produced and baking the shaped body resulting from the reshaping to a residual moisture of 1-29% by weight.

25. The method according to claim 24, which comprises baking the shaped body to a residual moisture of 1.5-18% by weight.

26. The method according to claim 21, wherein the step of producing the pre-product comprises baking a raw dough mix or baking mix in portions in a baking mold defining a shape of the article to be produced to form dimensionally stable, shaped bodies having a residual moisture of 1-6% by weight.

27. The method according to claim 26, which comprises forming the shaped bodies with a residual moisture of 1.5-4% by weight.

28. The method according to claim 21, wherein the step of producing the pre-product comprises baking a raw dough mix or baking mix in portions between opposing baking surfaces of a closed waffle baking mold to form dimensionally stable, shaped bodies having a residual moisture of 1-6% by weight.

29. The method according to claim 28, which comprises forming the shaped bodies with a residual moisture of 1.5-4% by weight.

30. The method according to claim 21, which comprises providing, as the dimensionally stable pre-product, baked pieces produced for fresh baked goods or long-life baked goods, at least partially baked goods or completely baked goods, bakery goods, and filled bakery goods.

31. The method according to claim 21, which comprises using a finished bakery product for the dimensionally stable pre-product.

32. The method according to claim 31, which comprises selecting the finished bakery product from the group consisting of biscuits, crackers, pretzels, baked sticks, and baked waffles.

33. The method according to claim 21, which comprises using, for the dimensionally stable pre-product, baked pieces that have been temporarily stored and chilled.

34. The method according to claim 21, which comprises using, for the dimensionally stable pre-product, baked pieces that have been temporarily stored frozen.

35. The method according to claim 21, which comprises, for producing an article that is glossy-brown on one side at least at given locations, treating only one side of the pre-product with lye during the production of the intermediate product.

36. The method according to claim 21, which comprises, for producing an article that is glossy-brown on both sides at least at given sites, in the production of the intermediate product, treating the pre-product with lye on only one side and subjecting to a first heat treatment, subsequently treating the intermediate product that is already browned on one side with lye on an opposite side and subjecting to a second heat treatment.

37. The method according to claim 36, which comprises, during the second heat treatment, shielding a side of the intermediate product that has been browned from the heat treatment.

38. The method according to claim 21, wherein the heat treatment comprises heat treating the intermediate product with hot air.

39. The method according to claim 21, wherein the heat-treating step comprises dividing a heat treatment of the intermediate product into a baking phase and a drying phase, wherein, in the baking phase, heating an outer skin of the intermediate product with hot air or infrared radiation up to a temperature at which gloss and color are produced at the lye-treated sites, and wherein, in the drying phase, heating an interior of the intermediate product with microwave or dielectric treatment in order to decrease the moisture content therein.

40. The method according to claim 21, wherein the step of treating with lye comprises using a lye solution admixed with at least one of modified starch and modified cereal flour.

41. The method according to claim 21, which comprises storing the pre-product chilled prior to treating with lye.

42. The method according to claim 21, which comprises storing the pre-product frozen prior to treating with lye.

43. An article having a glossy-brown surface, at least at given sites, produced with the method according to claim 21.

44. A food product having a glossy-brown surface at least at given sites, comprising: a baked and subsequently further heat-treated shaped body made from dough mix or baking mix, wherein the baked and further heat-treated body has been lye-treated, at least at given sites thereof, after the baking operation, the shaped body having a glossy, browned covering layer on the given lye-treated sites.

45. In combination with a container, a product comprising a baked and subsequently lye-treated shaped body made from dough mix or baking mix, wherein the shaped body is lye-treated after the baking operation at least at given sites, and the shaped body is subsequently further heat-treated, and the shaped body has a glossy, browned covering layer on the lye-treated given sites.
